(19) United States
(12) Patent Application Publication
(10) Pub. No.: US 2025/0158941 A1
(43) Pub. Date: May 15, 2025

(54) INFORMATION PROCESSING METHOD, A DEVICE, AND A MEDIUM

(71) Applicant: Beijing Zitiao Network Technology Co., Ltd., Beijing (CN)

(72) Inventors: Yiguo WANG, Beijing (CN); Xin ZHONG, Beijing (CN)

(21) Appl. No.: 18/937,971

(22) Filed: Nov. 5, 2024

(30) Foreign Application Priority Data
Nov. 15, 2023 (CN) 202311526742.3

(51) Int. Cl. H04L 51/02; G06F 16/33; H04L 51/216

(52) U.S. Cl. CPC H04L 51/02; G06F 16/3344; H04L 51/216

(57) ABSTRACT

The present disclosure provides an information processing method, a device, and a medium. The method includes: displaying reply information of a digital assistant in an interactive window between a user and the digital assistant, the reply information is generated based on first request information of the user; and in response to a preset operation associated with the reply information, displaying first content, where the first content is content about a generation process of the reply information.

### CROSS-CITATION TO RELATED APPLICATIONS

This application claims the priority to and benefits of the Chinese Patent Application, No. 202311526742.3, which was filed on Nov. 15, 2023. The aforementioned patent application is hereby incorporated by citation in its entirety.

### TECHNICAL FIELD

The present disclosure relates to the field of computer technologies, and in particular, to an information processing method, an electronic device, and a computer-readable storage medium.

### BACKGROUND

With the rapid development of computer technologies, digital assistants come into being. A user can interact with a digital assistant in a human-computer dialogue manner. Specifically, the user can input question information through the digital assistant, and the digital assistant can analyze the question information and generate reply information for the question information, to achieve human-computer dialogue.

Generally, reply information of the digital assistant may include a reference identifier. The reference identifier may be used to indicate a reference document referenced by the reply information. In other words, the reply information may be generated based on the reference document.

However, in human-computer dialogue, the user often has doubt about the credibility of the reply information, and it is difficult for the user to determine a cause of the inaccuracy of the reply information only through the reference identifier, and further, it is difficult for the user to improve the reply accuracy of the digital assistant.

### SUMMARY

The present disclosure provides an information processing method. The method can display a generation process of reply information to a user in an interactive page of a digital assistant, so that the user can optimize existing segment content through the generation process of the reply information, thereby improving the reply accuracy of human-computer dialogue. The present disclosure further provides a system, an electronic device, a computer-readable storage medium, and a computer program product corresponding to the method.

According to a first aspect, the present disclosure provides an information processing method. The method comprises:
displaying, in an interactive window between a user and a digital assistant, reply information of the digital assistant, wherein the reply information is generated based on first request information of the user; and
in response to a preset operation associated with the reply information, displaying first content, wherein the first content is content about a generation process of the reply information.

According to a second aspect, the present disclosure provides an information processing system. The system comprises:
a first display module, configured to display, in an interactive window between a user and a digital assistant, reply information of the digital assistant, wherein the reply information is generated based on first request information of the user; and
a second display module, configured to in response to a preset operation associated with the reply information, display first content, wherein the first content is content about a generation process of the reply information.

According to a third aspect, the present disclosure provides an electronic device. The electronic device comprises a processor and a memory. The processor and the memory communicate with each other. The processor is configured to execute instructions stored in the memory, to enable the electronic device to perform the information processing method according to the first aspect or any implementation of the first aspect.

According to a fourth aspect, the present disclosure provides a computer-readable storage medium. Instructions are stored in the computer-readable storage medium, and the instructions instruct an electronic device to perform the information processing method according to the first aspect or any implementation of the first aspect.

According to a fifth aspect, the present disclosure provides a computer program product comprising instructions, which, when running on an electronic device, the electronic device may perform the information processing method according to the first aspect or any implementation of the first aspect.

Based on the implementations provided in the foregoing aspects, the present disclosure can be further combined to provide more implementations.

### BRIEF DESCRIPTION OF DRAWINGS

In order to describe the technical methods of the embodiments of the present disclosure more clearly, the accompanying drawings used in the embodiments are briefly described below.

FIG. 1 is a schematic diagram of an interactive window according to an embodiment of the present disclosure;

FIG. 2 is a schematic flowchart of an information processing method according to an embodiment of the present disclosure;

FIGS. 3A to 3G are schematic diagrams of another interactive window according to an embodiment of the present disclosure;

FIG. 4 is a schematic diagram of a structure of an information processing system according to an embodiment of the present disclosure; and

FIG. 5 is a schematic diagram of a structure of an electronic device according to an embodiment of the present disclosure.

### DETAILED DESCRIPTION

The terms “first” and “second” in the embodiments of the present disclosure are used for descriptive purposes only, and cannot be understood as indicating or implying relative importance or implicitly indicating the number of indicated technical features. Therefore, a feature defined with “first” and “second” may explicitly or implicitly include one or more of the features.

Some technical terms involved in the embodiments of the present disclosure are first introduced.

With the rapid development of computer technologies, digital assistants come into being. A user can interact with a digital assistant in a human-computer dialogue manner. Specifically, the user can input request information through the digital assistant, and the digital assistant can analyze the request information and generate reply information for the request information, to achieve human-computer dialogue.

For example, the user can input request information “What process does a client need to go through to apply for a function A?” through the digital assistant. For the request information, the digital assistant can generate reply information “To apply for the function A, the client first needs to obtain an invitation code, and then a product owner determines whether the client has an actual requirement scenario; if the client meets the requirements, a small number of places will be opened to the client for internal testing” for the request information.

In some examples, the digital assistant may be deployed in a business platform. In other words, the digital assistant may be used as a system module of the business platform to provide a human-computer dialogue function. In this case, the digital assistant may query content (for example, a document) in another system module in the business platform based on the request information input by the user, to generate the reply information for the request information.

Generally, reply information of the digital assistant may include a reference identifier. The reference identifier may be used to indicate reference content (for example, a reference document) referenced by the reply information. In other words, the reply information may be generated based on the reference content.

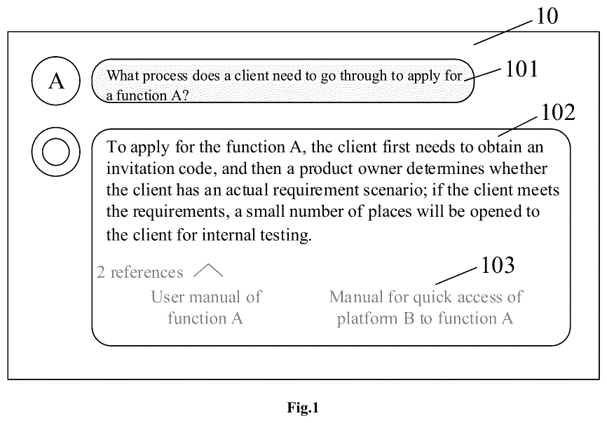

FIG. 1 is a schematic diagram of an interactive window. An interactive window 10 includes request information 101 input by a user and reply information 102 generated by a digital assistant for the request information. The reply information 102 includes a reference identifier 103. The reference identifier 103 may be used to indicate reference content “User manual of function A” and “Manual for quick access of platform B to function A” referenced by the reply information.

In some examples, the reference identifier 103 may be presented in the form of a link. The user can click on the reference identifier 103 in the interactive page 10 to view the reference content. For example, the user can click on “User manual of function A” to view document content corresponding to the user manual of function A, or click on “Manual for quick access of platform B to function A” to view document content corresponding to the manual for quick access of platform B to function A.

The reference identifier is presented in the reply information, so that the user can understand the reference content referenced by the reply information of the digital assistant. However, the reference identifier can only provide the reference content referenced by the reply information for the user, and it is difficult for the user to quickly determine, through the reference identifier, specific content (for example, content in some specific paragraphs) related to the request information in the reference content. In addition, in an interactive process with the digital assistant, the user often has doubt about the credibility of the reply information, and it is difficult for the user to determine a cause of the inaccuracy of the reply information only through the reference identifier, and further, it is difficult for the user to improve the reply accuracy of the digital assistant.

In view of this, the present disclosure provides an information processing method. The method displays, in an interactive window between a user and a digital assistant, reply information of the digital assistant, wherein the reply information is generated based on first request information of the user, and in response to a preset operation associated with the reply information, displays first content, wherein the first content is content about a generation process of the reply information.

In the method, in an interactive page with the digital assistant, the user can view content about the generation process of the reply information by triggering the preset operation associated with the reply information. In this way, the user can understand the generation process of the reply information, and information provided to the user in an interactive process with the digital assistant is enriched. When the reply information of the digital assistant is inaccurate, the user may also determine a cause of the inaccuracy of the reply information based on the generation process of the reply information. Furthermore, the user can optimize the generation process of the reply information, to improve the reply accuracy of the digital assistant subsequently.

To facilitate understanding of the technical solutions provided in the embodiments of the present disclosure, the following descriptions are made with reference to the accompanying drawings.

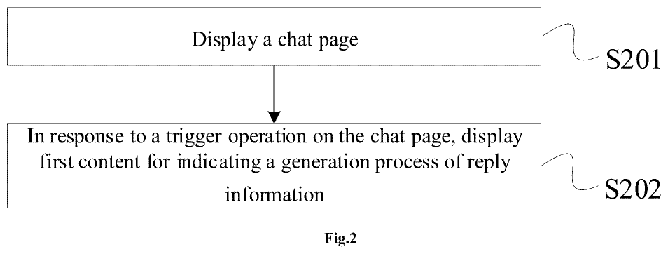

FIG. 2 is a schematic flowchart of an information processing method according to an embodiment of the present disclosure. The method may be applied to a client. The method specifically includes the following steps.

S201: Display, in an interactive window between a user and a digital assistant, reply information of the digital assistant.

The interactive window may be understood as a window for human-computer dialogue. Depending on application scenarios, the interactive window may be presented in different forms. For example, when the user uses an independent digital assistant for human-computer dialogue, the interactive window may be a page loaded in a client corresponding to the digital assistant. For another example, when the user uses a digital assistant (for example, a digital assistant module in a business platform) deployed in another system (for example, a business platform) for human-computer dialogue, the interactive window may be a page loaded in a client corresponding to the other system. For another example, when the user uses a digital assistant that can be used online for human-computer dialogue, the interactive window may be a page displayed in a browser.

In the embodiments of the present disclosure, the interactive window may be presented in different forms. Specifically, the interactive window may include one or more of the following: a chat window between the user and the digital assistant, a group chat window comprising the user and the digital assistant, and a floating window of the digital assistant.

In other words, the digital assistant may provide a human-computer dialogue service for the user in different scenarios. When the interactive window is a chat window between the user and the digital assistant, the user may start a dialogue with the digital assistant in the chat window, and the digital assistant may generate reply information for request information input by the user, to implement one-to-one human-computer dialogue.

When the interactive window is a group chat window comprising the user and the digital assistant, a plurality of group members in a group chat, including the user in the embodiments of the present disclosure, may start a dialogue with the digital assistant in the group chat, and the digital assistant may generate reply information for request information input by any one of the plurality of group members, to implement one-to-many human-computer dialogue.

When the interactive window is a floating window of the digital assistant, the digital assistant may be deployed in a system module. For example, the digital assistant may be deployed in a document module. The user may start a document page in the document module, and call the floating window of the digital assistant in the document page, to start a dialogue with the digital assistant through the floating window of the digital assistant. The digital assistant may generate reply information for request information (for example, request information related to document content) input by the user, to implement human-computer dialogue in different system modules.

In the embodiments of the present disclosure, the reply information of the digital assistant is generated for first request information of the user. The first request information is usually the information that is input by the user and needs to be replied to. The reply information for the first request information may be understood as the information that is generated by the digital assistant and is used to reply to the first request information. For example, when the first request information is “What is generative artificial intelligence”, the reply information may be “Generative artificial intelligence is a technology for generating related content with an appropriate generalization capability through learning and recognizing of existing data, based on artificial intelligence methods such as a generative adversarial network and a pre-trained model”.

In some possible implementations, an input box may be provided in the interactive window, and the user may trigger the input box and enter the first request information in the input box. In some embodiments, the user may input information in a text form. In this case, text entered by the user in the input box is the first request information. In some other embodiments, when a device used by the user supports voice input, the user may also input information in a voice form. In this case, the user may trigger a voice input control in the input box to perform voice input, and the first request information may be obtained by converting the voice of the user into text.

After the user completes the input of the first request information, an input request may be triggered by clicking an information sending control, to send the first request information to a server of the digital assistant. In this case, the input information may be displayed in the interactive window of the client.

In some possible implementations, the digital assistant may generate the reply information based on a natural language processing capability of a language model. In a specific implementation, the server of the digital assistant may send the first request information to the language model, so that the language model processes the first request information and returns the reply information for the first request information.

The language model has a natural language processing capability, and may be used to process a natural language task. For example, the language model may be a deep learning model trained by using text data. By analyzing semantics of the first request information, the language model may identify an intention of the user for human-computer dialogue, and further generate the reply information for the first request information. In this way, the reply information is generated by using the language model, to complete one round of human-computer dialogue.

S202: In response to a preset operation associated with the reply information, display first content.

The preset operation may be understood as an operation for viewing the first content. For example, the interactive window may provide a view control, and the preset operation may be an operation of the user triggering the view control. For another example, the preset operation may also be a voice input operation of the user inputting an instruction for viewing the first content in the interactive window. For another example, the preset operation may also be a text input operation of the user inputting the information for viewing the first content in the interactive window. This is not limited in the embodiments of the present disclosure.

The first content is content about the generation process of the reply information. In other words, by displaying the first content, the user can learn the generation process of the reply information by viewing the first content.

In the embodiments of the present disclosure, the first content may include at least one segment matching result, and the reply information of the digital assistant may be generated based on the at least one segment matching result.

The segment matching result may be associated with the first request information. In other words, the segment matching result may be content related to the first request information, for example, content related to a topic of the first request information or content related to semantics of the first request information.

Specifically, the segment matching result corresponds to segment content. The segment content may be understood as some content in a text. For example, the text may be a document, and in this case, the segment content may be some paragraphs in the document. For another example, the text may be web page content, and in this case, the segment content may be some paragraphs in the web page content. For another example, the text may be text related to a video (for example, text corresponding to voice in the video or text presented in the video), and in this case, the segment content may be text related to some video frames in the video.

In different application scenarios, a source of the segment content corresponding to the segment matching result may be different. In some embodiments, the user uses an independent digital assistant for human-computer dialogue, that is, the digital assistant is an independent software system. In this case, the segment content corresponding to the segment matching result may be from text locally stored in a device used by the user. In some other embodiments, the user uses a digital assistant (for example, a digital assistant module in a business platform) deployed in another system (for example, a business platform) for human-computer dialogue, that is, the digital assistant is a function module deployed in the other system. In this case, the segment content corresponding to the segment matching result may be from text stored in a server of the other system (for example, the business platform). In some other embodiments, the user uses a digital assistant that can be used online for human-computer dialogue. In this case, the segment content corresponding to the segment matching result may be from text on a network. In other words, the segment content corresponding to the segment matching result may be from internal knowledge or external knowledge.

Because the reply information may be generated by performing natural language processing on the first request information by using a language model, and a processing process of the language model is a “black box” for the user, and the user cannot learn a specific generation process of the reply information. Therefore, through displaying the first content including the at least one segment matching result, the user can learn the segment content corresponding to the matching result for generating the reply information, and thus accurately learn which segments the reply information specifically comes from, instead of being limited to a specific document. In this way, the credibility of the reply information is improved.

In some embodiments, the first content may further include the first request information and/or the reply information. For example, the first request information may be displayed in a first area of the interactive window, the at least one segment matching result may be displayed in a second area of the interactive window, and the reply information may be displayed in a third area of the interactive window.

The first request information, the at least one segment matching result, and the reply information are displayed in different areas of the interactive window, so that the generation process of the reply information can be more visually presented to the user, that is, the first request information of the user is first obtained, the segment matching result is determined based on the first request information, and then the reply information is generated based on the segment content corresponding to the segment matching result.

In this way, the user can learn the segment content for generating the reply information by viewing the first content. When the user is not satisfied with the reply information, the user can determine whether there is an error in the segment matching result by viewing the at least one segment matching result, that is, whether a cause of a deviation in the reply information is an incorrect matching result caused by an error in matching between the first request information and the segment content.

In some embodiments, the first area may be located in an upper area of the interactive window, the second area may be located in a middle area of the interactive window, and the third area may be located in a lower area of the interactive window. In other words, the first area is located above the second area, and the second area is located above the third area. In this way, corresponding content is displayed in the first area, the second area, and the third area in sequence based on the generation process of the reply information.

In some possible implementations, the segment matching results may be displayed in a specific order. In a specific implementation, sequence information of the at least one segment matching result may be determined based on a matching degree between segment content corresponding to the at least one segment matching result and the first request information, and the first content corresponding to the sequence information of the at least one matching result is displayed.

The matching degree may be used to indicate a degree of association between the segment content corresponding to the segment matching result and the first request information. The higher the matching degree, the stronger the degree of association between the segment content corresponding to the segment matching result and the first request information. The lower the matching degree, the weaker the degree of association between the segment content corresponding to the segment matching result and the first request information.

A matching degree between the segment content corresponding to the segment matching result and the first request information may be determined by a text matching algorithm. The text matching algorithm may measure the matching degree between the segment content corresponding to the segment matching result and the first request information from a plurality of dimensions, including but not limited to text similarity between the segment content and the first request information, semantic similarity between the segment content and the first request information, an authority degree of the segment content, a timeliness degree of the segment content, and the like.

It can be understood that when generating the reply information, the language model may refer to segment content with a high degree of association with the first request information. Therefore, the sequence information of the segment matching result may be that a segment matching result with a high matching degree is ranked higher, and a segment matching result with a low matching degree is ranked lower. In this way, the segment matching results are displayed in sequence from a high matching degree to a low matching degree.

The segment matching result is described in detail below. In some embodiments, the segment matching result may include at least one of the following: source information of segment content, preview information of the segment content, and identification information of the segment content.

The source information of the segment content may represent a source of the segment content, that is, text to which the segment content belongs, for example, a specific document, a specific web page, or the like. The preview information of the segment content may represent the segment content. It can be understood that since it is difficult to completely display the segment content corresponding to the segment matching result in the segment matching result, some information of the segment content may be displayed in the form of displaying the preview information of the segment content. For example, the preview information of the segment content may be first N words of the segment content, and a specific value of N may be determined based on an area that can be used to display the preview information of the segment content. For another example, the preview information of the segment content may also be summary information of the segment content. This is not limited in the embodiments of the present disclosure.

Furthermore, the segment matching result may further include one or more of the following: a matching degree between the segment content and the first request information, identification information of the segment matching result, and sequence information of the matching result.

The matching degree between the segment content and the first request information may be presented in the form of a value, so that the matching degree information is intuitively notified to the user. The identification information of the segment matching result may be used to identify that the reply information is generated based on the segment matching result, so that the segment matching result that the digital assistant refers to in the process of generating the reply information is intuitively notified to the user. The sequence information of the matching result may be presented in the form of numbers, for example, “1.”, “2.”, etc.

The first content includes various types of information related to the segment matching result, to enrich information types that can be viewed and obtained by the user through the first content. In this way, by providing the first content, the user can learn various pieces of information such as the segment matching result related to the first request information, the matching degree of each segment matching result, the source of the segment content, preview content of the segment content, and the like, and has a concrete understanding of the processing of the first request information by the language model.

It can be understood that in the embodiments of the present disclosure, a matching result related to the first request information of the user but are not referenced when the language model generates the reply information (which may also be referred to as an unreferenced matching result) may also be provided in the interactive window. For example, a matching degree between segment content corresponding to the unreferenced matching result and the first request information may be less than a matching degree threshold. By displaying the unreferenced matching result to the user, the user can further learn more matching results related to the first request information. In this way, when the user is not satisfied with the reply information, the user may select, from segment content corresponding to the unreferenced matching result, segment content similar to the intention of the user, and instruct the digital assistant to regenerate the reply information based on the segment content corresponding to the unreferenced matching result selected by the user, to improve the accuracy of the reply of the digital assistant.

In some embodiments, considering that the segment matching result may include only preview information of the segment content, the user may view complete segment content corresponding to the segment matching result through a trigger operation. In a specific implementation, the first content may include a first segment matching result, and in response to a first trigger operation for the first content, second content may be displayed, where the second content includes segment content corresponding to the first segment matching result. For example, the first trigger operation may be a trigger operation for preview information of the segment content in the first segment matching result, or when the first content further includes a segment content view control, the first trigger operation may also be a trigger operation for the segment content view control in the first content. This is not limited in the embodiments of the present disclosure.

In this way, in the process of human-computer dialogue, the user can browse specific segment content for generating the reply information by viewing the generation process of the reply information. When the user is not satisfied with the reply information, whether there is an error in the segment content may be further determined by browsing the segment content corresponding to the segment matching result, that is, whether a cause of a deviation in the reply information is an error in the segment content.

Further, when there is an error in the segment content, the user may further modify the segment content. In a specific implementation, the first content may include a first segment matching result, and in response to a second trigger operation for the first content, a source page of segment content corresponding to the first segment matching result is displayed. Display content of the source page may be the segment content corresponding to the first segment matching result.

In some embodiments, the second trigger operation may include an operation associated with source information of the segment content in the first content. For example, the second trigger operation may be a trigger operation for the source information of the segment content, or when the first content further includes a source view control, the first trigger operation may also be a trigger operation for the source view control. This is not limited in the embodiments of the present disclosure.

The source page may be understood as a page where the text to which the segment content belongs is located. For example, when the text is a document, the source page may be a document page. For another example, when the text is a web page, the source page may be a web page.

In other words, in the embodiments of the present disclosure, the client is supported to jump to the page where the text to which the segment content belongs is located, and position to a location of the segment content in the source page to display the segment content (for example, a specific paragraph). In this way, when there is an error in the segment content, the user can quickly modify and optimize the segment content in the source page, thereby improving the accuracy and effect of the reply information in subsequent human-computer dialogue.

Based on the foregoing description of content, the embodiments of the present disclosure provide an information processing method. The method comprises displaying, in an interactive window between a user and a digital assistant, reply information of the digital assistant, wherein the reply information is generated based on first request information of the user; and then, in response to a preset operation associated with the reply information, displaying a first content, wherein the first content is content about a generation process of the reply information.

In the method, in an interactive page with the digital assistant, the user can view the content about the generation process of the reply information by triggering the preset operation associated with the reply information. In this way, the user can understand the generation process of the reply information, and information provided to the user in an interactive process with the digital assistant is enriched. When the reply information of the digital assistant is inaccurate, the user may also determine a cause of the inaccuracy of the reply information based on the generation process of the reply information. Furthermore, the user can optimize the generation process of the reply information, to improve the reply accuracy of the digital assistant subsequently.

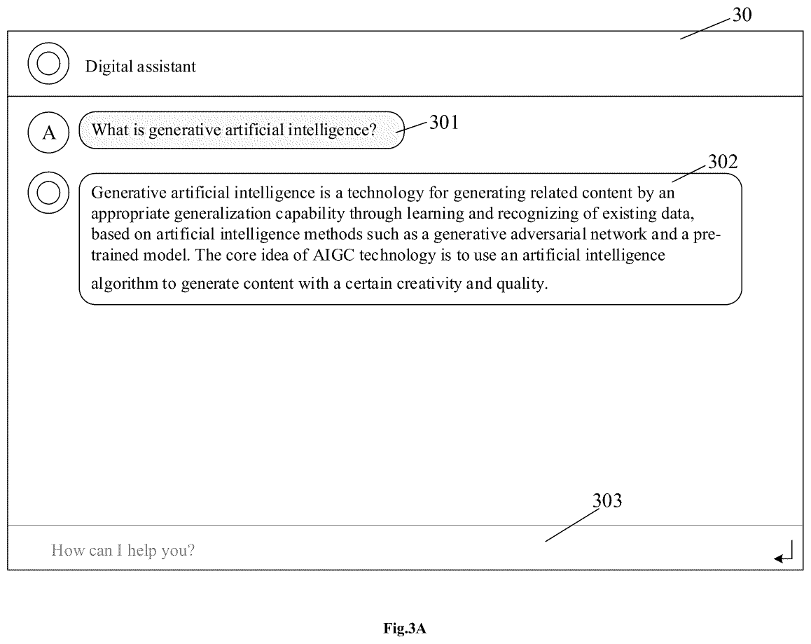

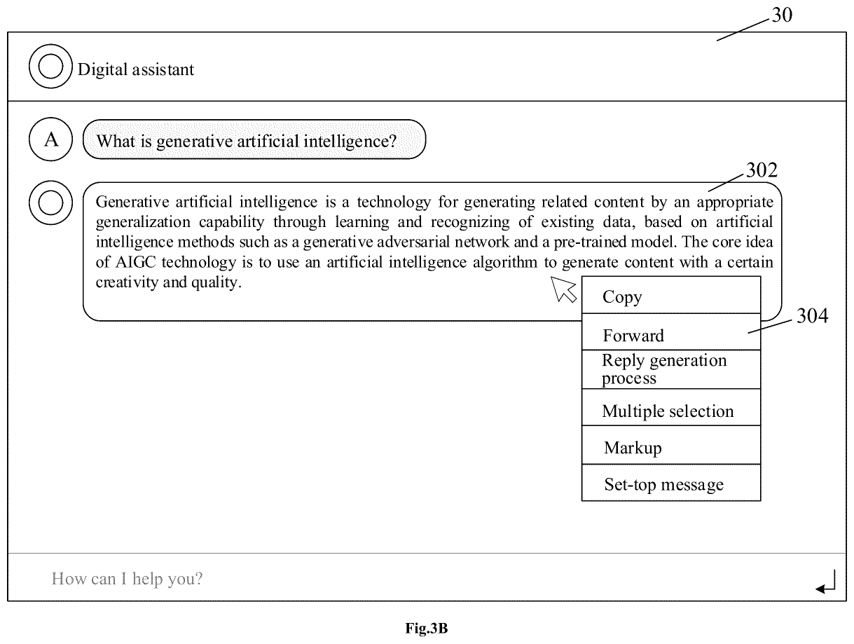

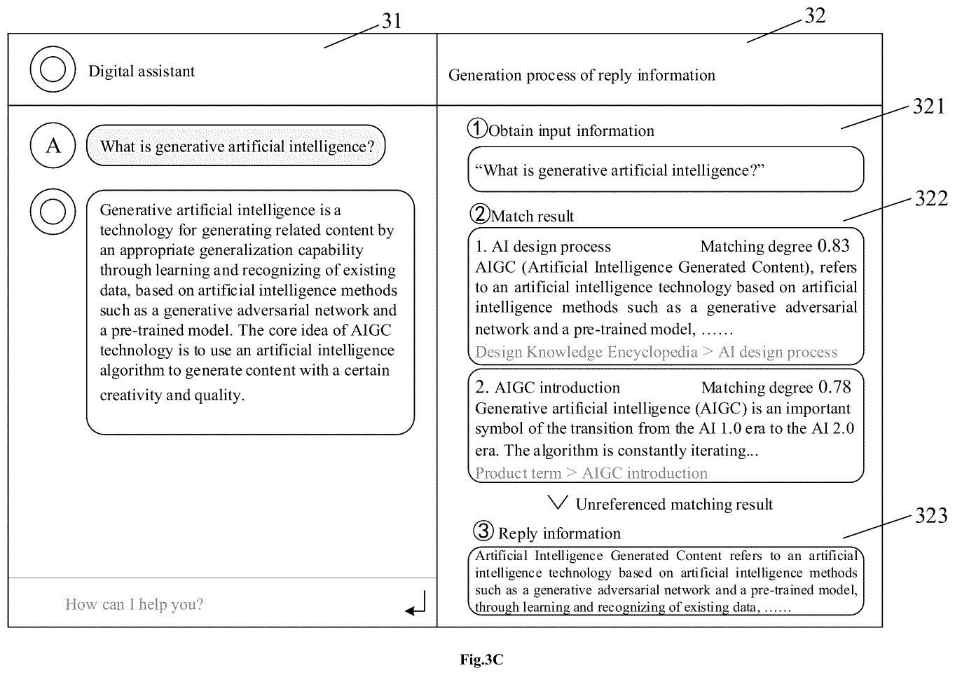

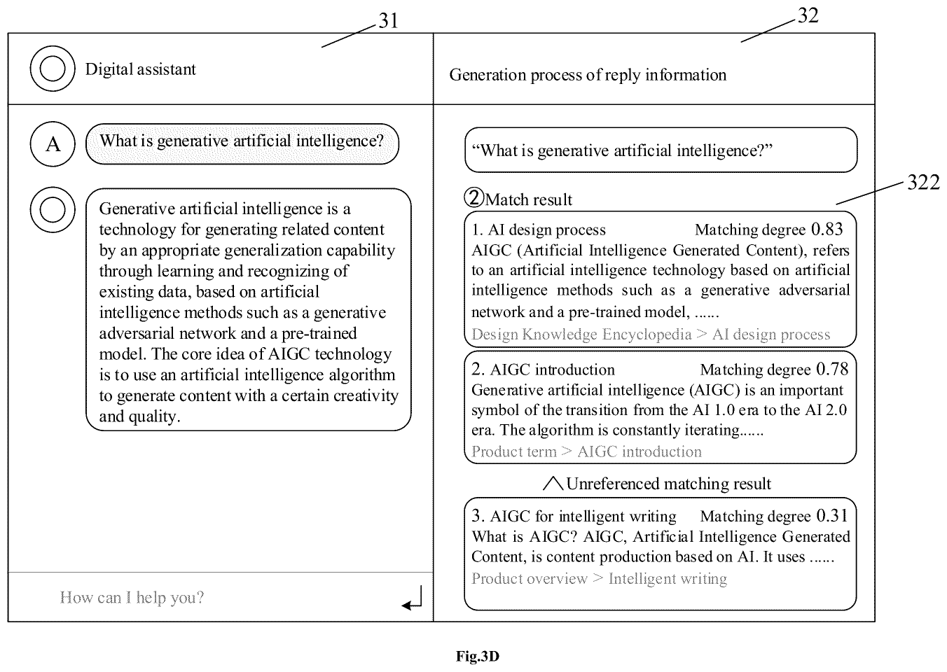

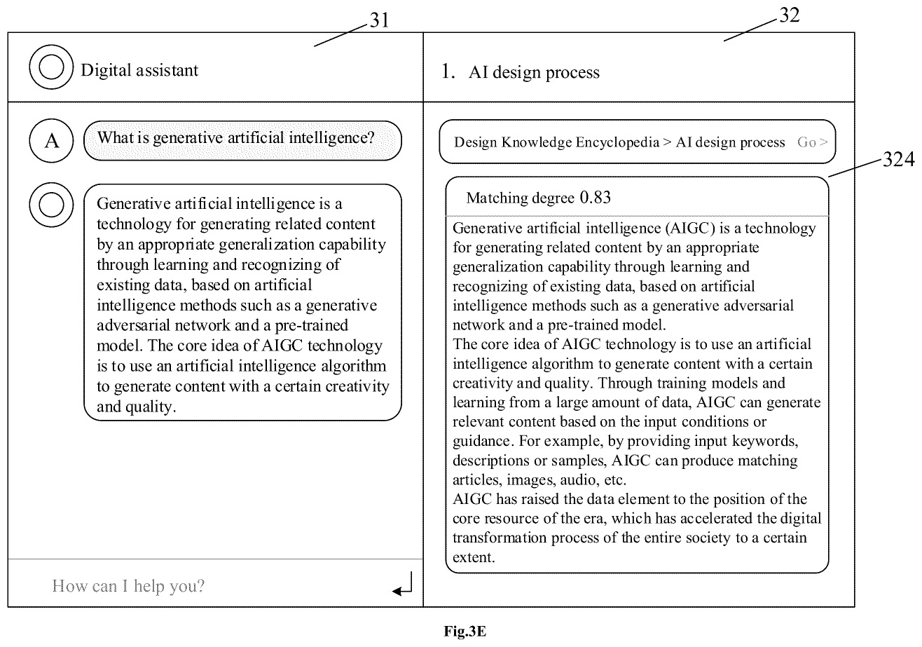

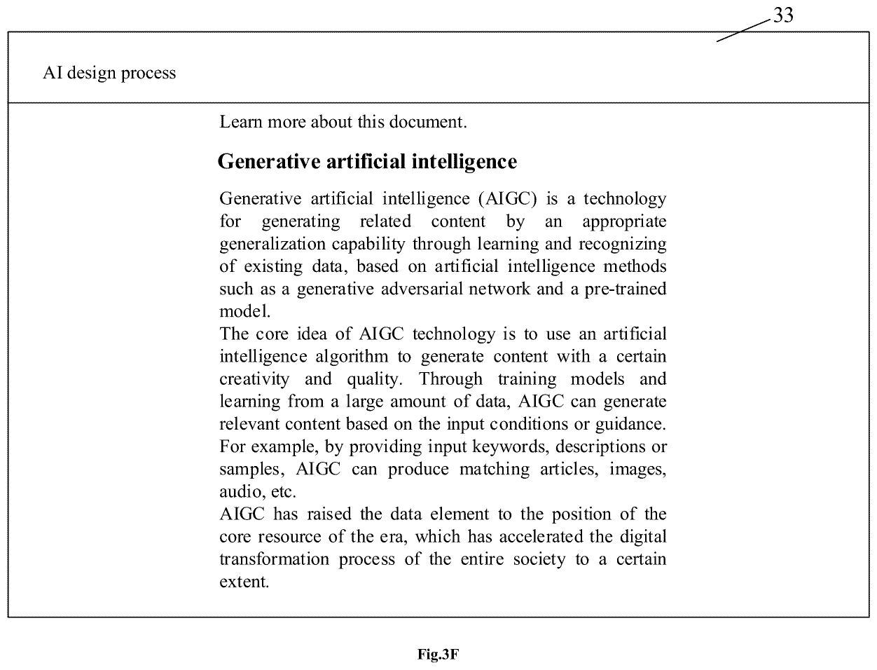

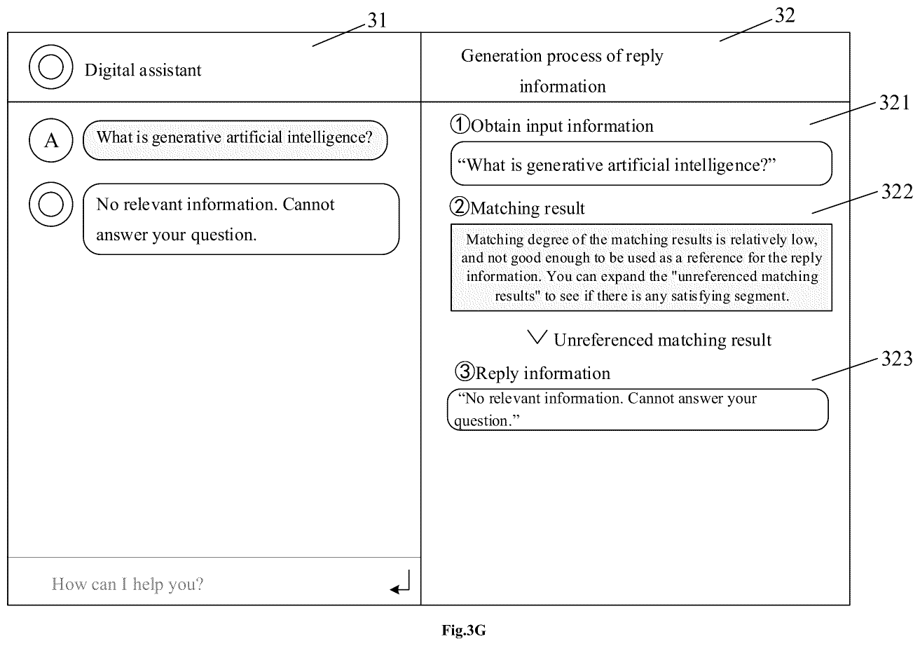

An information processing method provided in the embodiments of the present disclosure will be described below with reference to a specific chat page. FIGS. 3A to 3G are schematic diagrams of an interactive window. In FIG. 3A, an interactive window 30 displays first request information 301 and reply information 302 for the first request information. The first request information 301 is “What is generative artificial intelligence?”, and the reply information 302 is “Generative artificial intelligence is a technology for generating related content by an appropriate generalization capability through learning and recognizing of existing data, based on artificial intelligence methods such as a generative adversarial network and a pre-trained model. The core idea of AIGC technology is to use an artificial intelligence algorithm to generate content with a certain creativity and quality”. In some embodiments, the first request information 301 may be input by the user through an input box 303.

The user can trigger the preset operation associated with the reply information in the interactive window 30 to view content about the generation process of the reply information. As shown in FIG. 3B, after the user triggers the reply information 302, for example, by right-clicking on the reply information 302, a control window 304 may be displayed. The control window 304 includes a “reply generation process” control, and the preset operation in this embodiment of the present disclosure may be a trigger operation for the “reply generation process” control. In addition, the control window 304 may further include other controls, for example, a copy control, a forward control, a multiple selection control, a markup control, a set-top message control, and the like.

The first content is displayed in response to the preset operation associated with the reply information. As shown in FIG. 3C, the interactive window 30 may include a chat information display area 31 and a first content display area 32. The first content about the generation process of the reply information is displayed in the first content display area 32.

Specifically, the first content display area 32 includes a first area 321, a second area 322, and a third area 323. The first area 321 is used to display the first request information, to notify the user that a first step of the language model processing the input information is to obtain the first request information. The second area 322 is used to display at least one segment matching result associated with the first request information, for example, the segment matching result is displayed based on sequence information of the segment matching result. In addition, the second area 322 may further display a matching degree between the segment content corresponding to the segment matching result and the first request information, source information of the segment content, and preview information of the segment content. The third area 323 is used to display the reply information, to notify the user that the language model may generate the reply information based on the segment matching result.

Furthermore, the second area 322 includes a first control. The first control may be an “unreferenced matching result” control, and the user may view an unreferenced matching result by triggering the “unreferenced matching result” control. As shown in FIG. 3D, the second area 322 displays the segment matching result and the unreferenced matching result, where the unreferenced matching result may be associated with the first request information, but the reply information is not generated based on segment content corresponding to the unreferenced matching result, that is, the language model does not refer to the segment content corresponding to the unreferenced matching result when generating the reply information.

The user may perform a first trigger operation on the first content (for example, a target matching result in the segment matching result) to view specific segment content corresponding to the segment matching result. As shown in FIG. 3E, the first content display area 32 includes a segment content display area 324, and the segment content display area 324 is used to display the specific segment content corresponding to the segment matching result. For example, the specific segment content corresponding to the segment matching result may be segment content from AI design process under Design Knowledge Encyclopedia.

Further, the user may perform a second trigger operation on the first content (for example, source information of the segment content) to view the segment content in a source page of the segment content. As shown in FIG. 3F, a source page 33 may be a document page corresponding to the document AI design process under Design Knowledge Encyclopedia. In the source page 33, the location of the segment content is located to display the segment content, so that the user can optimize the segment content in the source page.

In addition, in some embodiments, the digital assistant may fail to generate valid reply information. As shown in FIG. 3G, the language model does not determine a segment matching result based on the input information, for example, when a matching degree between the segment matching result and the first request information is relatively low, the segment content corresponding to the segment matching result is not good enough to be used as a reference for the reply information, and in this case, the reply information may be “No relevant information. Cannot answer your question”.

The information processing method provided in the embodiments of the present disclosure is described in detail above with reference to FIG. 1 to FIG. 3. The following describes the system and the device provided in the embodiments of the present disclosure with reference to the accompanying drawings.

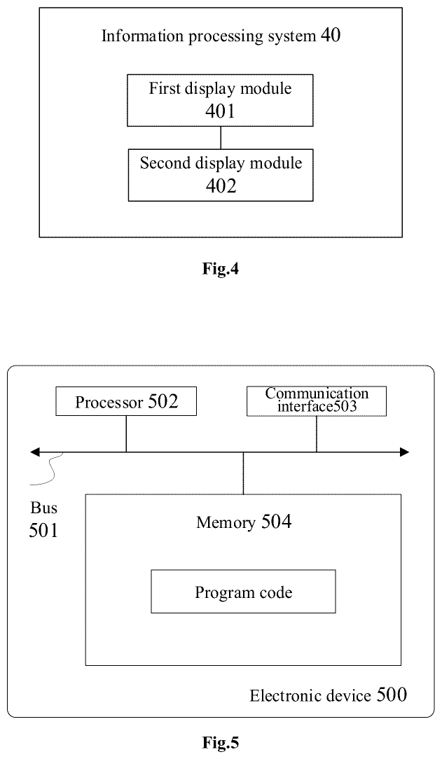

FIG. 4 is a schematic diagram of a structure of an information processing system. The system 40 includes:
a first display module 401, configured to display, in an interactive window between a user and a digital assistant, reply information of the digital assistant, wherein the reply information is generated based on first request information of the user; and
a second display module 402, configured to in response to a preset operation associated with the reply information, display first content, wherein the first content is content about a generation process of the reply information.

In some possible implementations, the interactive window includes one or more of the following:
a chat window between the user and the digital assistant;
a group chat window comprising the user and the digital assistant; and
a floating window of the digital assistant.

In some possible implementations, the first content comprises:
at least one segment matching result; and
the reply information is generated based on the at least one segment matching result.

In some possible implementations, the first content comprises:
the first request information; and/or
the reply information.

In some possible implementations, the segment matching result includes at least one of the following:
source information of the segment content, preview information of the segment content, and identification information of the segment content.

In some possible implementations, the segment matching result further includes one or more of the following:
a matching degree between the segment content and the first request information;
identification information of the segment matching result, wherein the identification information is used to identify that the reply information is generated based on the segment matching result; and
sequence information of the matching result.

In some possible implementations, the first content includes at least one segment matching result, and the second display module 402 is specifically configured to:
determine the sequence information of the at least one matching result based on the matching degree between segment content corresponding to the at least one matching result and the first request information; and
display the first content corresponding to the sequence information of the at least one matching result.

In some possible implementations, the first content includes a first segment matching result, and the system further includes a third display module, configured to:
in response to a first trigger operation for the first content, display second content, wherein the second content includes segment content corresponding to the first segment matching result.

In some possible implementations, the first content includes a first segment matching result, and the system further includes a fourth display module, configured to:
in response to a second trigger operation for the first content, display a source page of the segment content corresponding to the first segment matching result, wherein display content of the source page is the segment content corresponding to the first segment matching result.

In some possible implementations, the second trigger operation includes an operation associated with source information of the segment content in the first content.

In some possible implementations, the digital assistant generates the reply information based on a natural language processing capability of a language model.

The information processing system 40 according to the embodiment of the present disclosure may correspond to execution of the method described in the embodiment of the present disclosure, and the foregoing and other operations and/or functions of each module/unit of the information processing system 40 are respectively used to implement corresponding processes in the method in the embodiment shown in FIG. 2. For brevity, the details are not described herein again.

An embodiment of the present disclosure further provides an electronic device. The electronic device is specifically configured to implement the function of the information processing system 40 in the embodiment shown in FIG. 4.

FIG. 5 is a schematic diagram of a structure of an electronic device 500. As shown in FIG. 5, the electronic device 500 includes a bus 501, a processor 502, a communication interface 503, and a memory 504. The processor 502, the memory 504, and the communication interface 503 communicate with each other through the bus 501.

The bus 501 may be a peripheral component interconnect (PCI) bus, an extended industry standard architecture (EISA) bus, or the like. The bus may be classified into an address bus, a data bus, a control bus, and the like. For ease of illustration, only one thick line is used to represent a bus in FIG. 5, but this does not indicate that there is only one bus or one type of bus.

The processor 502 may be any one or more of a central processing unit (CPU), a graphics processing unit (GPU), a microprocessor (MP), and a digital signal processor (DSP).

The communication interface 503 is configured to communicate with an external device. For example, the communication interface 503 may be configured to communicate with a terminal.

The memory 504 may include a volatile memory, for example, a random access memory (RAM). The memory 504 may further include a non-volatile memory, for example, a read-only memory (ROM), a flash memory, a hard disk drive (HDD), or a solid state drive (SSD).

The memory 504 stores executable code, and the processor 502 executes the executable code to perform the foregoing information processing method.

Specifically, when the embodiment shown in FIG. 4 is implemented and each module or unit of the information processing system 40 described in the embodiment of FIG. 4 is implemented through software, software or program code required for executing the functions of each module/unit in FIG. 4 may be partially or completely stored in the memory 504. The processor 502 executes the program code corresponding to each unit stored in the memory 504 to perform the foregoing information processing method.

An embodiment of the present disclosure further provides a computer-readable storage medium. The computer-readable storage medium may be any usable medium that can be stored by a computing device or a data storage device such as a data center including one or more usable media. The usable medium may be a magnetic medium (for example, a floppy disk, a hard disk, or a magnetic tape), an optical medium (for example, a DVD), or a semiconductor medium (for example, a solid-state drive). The computer-readable storage medium includes instructions instructing a computing device to perform the information processing method applied to the information processing system 40.

An embodiment of the present disclosure further provides a computer program product. The computer program product includes one or more computer instructions. When the computer instructions are loaded and executed on a computing device, all or some of the processes or functions described in the embodiments of the present disclosure are generated.

The computer instructions may be stored in a computer-readable storage medium, or may be transmitted from one computer-readable storage medium to another computer-readable storage medium. For example, the computer instructions may be transmitted from a website, a computer, or a data center to another website, another computer, or another data center in a wired (for example, a coaxial cable, an optical fiber, or a digital subscriber line (DSL)) or wireless (for example, infrared, radio, or microwave) manner.

When the computer program product is executed by a computer, the computer executes any one of the foregoing information processing methods. The computer program product may be a software installation package. When any one of the foregoing information processing methods needs to be performed, the computer program product may be downloaded and executed on the computer.

The flowcharts and block diagrams in the accompanying drawings illustrate the possibly implemented architecture, functions, and operations of the system, method, and computer program product according to the embodiments of the present disclosure. In this regard, each block in the flowchart or block diagram may represent a module, program segment, or part of code, and the module, program segment, or part of code includes one or more executable instructions for implementing the specified logical functions. It should also be noted that in some alternative implementations, the functions indicated in the blocks may also occur in an order different from that indicated in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by a mode of software, or may be implemented by a mode of hardware. The name of a unit/module does not constitute a limitation on the unit itself in some cases.

The functions described herein above may be performed at least partially by one or more hardware logic components. For example, non-limiting exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the embodiments of the present disclosure, the machine-readable medium may be a visible medium that may contain or store a program for use by or in combination with an instruction executive system, apparatus, or device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It should be noted that in the present specification, the embodiments are described in a progressive manner, and each embodiment focuses on differences from other embodiments. For the same and similar parts of the embodiments, reference may be made to each other. For a system or apparatus disclosed in the embodiments, since it corresponds to the method disclosed in the embodiments, the description is relatively simple, and for related parts, reference may be made to the description of the method section.

It should be understood that in the present disclosure, “at least one (item)” means one or more, and “a plurality of” means two or more. “And/or” describes an association relationship between associated objects and represents that three relationships may exist. For example, “A and/or B” may represent the following three cases: only A exists, only B exists, and both A and B exist, where A and B may be singular or plural. The character “/” generally indicates that the associated objects before and after are an “or” relationship. “At least one of the following items (at least one of the following)” or a similar expression thereof means any combination of these items, including a single item (singular) or any combination of a plurality of items (plural). For example, at least one of a, b, or c may represent: a, b, c, “a and b”, “a and c”, “b and c”, or “a, b, and c”, where a, b, and c may be singular or plural.

It should also be noted that in this document, relational terms such as first and second are merely used to distinguish one entity or operation from another entity or operation, and do not necessarily require or imply any such actual relationship or order between these entities or operations. Moreover, the terms “include”, “comprise”, or any other variant thereof are intended to cover a non-exclusive inclusion, so that a process, method, product, or apparatus that includes a list of elements not only includes those elements but also includes other elements not explicitly listed, or further includes elements inherent to such process, method, product, or apparatus. Without more restrictions, an element defined by a statement “include a/an . . . ” does not exclude the existence of another identical element in the process, method, product, or apparatus that includes the element.

The steps of a method or algorithm described in connection with the embodiments disclosed herein may be implemented directly by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium well known in the art.

The foregoing descriptions of the disclosed embodiments enable those skilled in the art to implement or use the present disclosure. Various modifications to these embodiments are obvious to those skilled in the art, and the general principles defined herein may be implemented in other embodiments without departing from the spirit or scope of the present disclosure. Therefore, the present disclosure is not limited to the embodiments shown herein, but is to comply with the widest scope consistent with the principles and novel features disclosed herein.

1. An information processing method, comprising:
displaying, in an interactive window between a user and a digital assistant, reply information of the digital assistant, wherein the reply information is generated based on first request information of the user; and
in response to a preset operation associated with the reply information, displaying first content, wherein the first content is content about a generation process of the reply information.

2. The method according to claim 1, wherein the interactive window comprises one or more of the following:
a chat window between the user and the digital assistant;
a group chat window comprising the user and the digital assistant; and
a floating window of the digital assistant.

3. The method according to claim 1, wherein the first content comprises at least one segment matching result; and
the reply information is generated based on the at least one segment matching result.

4. The method according to claim 1, wherein the first content comprises:
the first request information; and/or
the reply information.

5. The method according to claim 3, wherein the segment matching result comprises at least one of the following:
source information of segment content, preview information of the segment content, and identification information of the segment content.

6. The method according to claim 5, wherein the segment matching result further comprises one or more of the following:
a matching degree between the segment content and the first request information;
identification information of the segment matching result, wherein the identification information is used for identifying that the reply information is generated based on the segment matching result; and
sequence information of the matching result.

7. The method according to claim 1, wherein the first content comprises at least one segment matching result, and the displaying first content comprises:
determining sequence information of the at least one matching result based on a matching degree between segment content corresponding to the at least one matching result and the first request information; and
displaying the first content corresponding to the sequence information of the at least one matching result.

8. The method according to claim 1, wherein the first content comprises a first segment matching result, and the method further comprises:
in response to a first trigger operation for the first content, displaying second content, wherein the second content comprises segment content corresponding to the first segment matching result.

9. The method according to claim 1, wherein the first content comprises a first segment matching result, and the method further comprises:
in response to a second trigger operation for the first content, displaying a source page of segment content corresponding to the first segment matching result, wherein display content of the source page is the segment content corresponding to the first segment matching result.

10. The method according to claim 9, wherein the second trigger operation comprises an operation associated with source information of the segment content in the first content.

11. The method according to claim 1, wherein the digital assistant generates the reply information based on a natural language processing capability of a language model.

12. An electronic device, comprising a processor and a memory;
the processor is configured to execute instructions stored in the memory, so that the electronic device perform the method according to claim 1.

13. A computer-readable storage medium, comprising instructions, the instructions instruct an electronic device to perform the method according to claim 1.

14. The electronic device according to claim 12, wherein the interactive window comprises one or more of the following:
a chat window between the user and the digital assistant;
a group chat window comprising the user and the digital assistant; and
a floating window of the digital assistant.

15. The electronic device according to claim 12, wherein the first content comprises at least one segment matching result; and
the reply information is generated based on the at least one segment matching result.

16. The electronic device according to claim 12, wherein the first content comprises:
the first request information; and/or
the reply information.

17. The electronic device according to claim 15, wherein the segment matching result comprises at least one of the following:
source information of segment content, preview information of the segment content, and identification information of the segment content.

18. The electronic device according to claim 17, wherein the segment matching result further comprises one or more of the following:
a matching degree between the segment content and the first request information;
identification information of the segment matching result, wherein the identification information is used for identifying that the reply information is generated based on the segment matching result; and
sequence information of the matching result.

19. The electronic device according to claim 12, wherein the first content comprises a first segment matching result, and the method further comprises:
in response to a first trigger operation for the first content, displaying second content, wherein the second content comprises segment content corresponding to the first segment matching result.

20. The electronic device according to claim 12, wherein the first content comprises a first segment matching result, and the method further comprises:
in response to a second trigger operation for the first content, displaying a source page of segment content corresponding to the first segment matching result, wherein display content of the source page is the segment content corresponding to the first segment matching result.
